(19) United States
(12) Patent Application Publication
(10) Pub. No.: US 2026/0029839 A1
(43) Pub. Date: Jan. 29, 2026

(54) SYSTEMS AND METHODS FOR AN EXTENDED REALITY ENVIRONMENT

(71) Applicant: CurioXR, Inc. (f/k/a VR-EDU, Inc.), Gainesville, FL (US)

(72) Inventor: Ethan FIELDMAN, Gainesville, FL (US)

(73) Assignee: CurioXR, Inc. (f/k/a VR-EDU, Inc.), Gainesville, FL (US)

(21) Appl. No.: 18/783,609

(22) Filed: Jul. 25, 2024

(51) Int. Cl. G06F 3/01; G06T 19/00; G09B 5/02

(52) U.S. Cl. CPC G06F 3/011; G06F 3/017; G06T 19/00; G09B 5/02; G06T 2200/24

(57) ABSTRACT

Methods, systems, apparatuses, and non-transitory computer readable media are provided for directing a user through an extended reality environment. Operations may include rendering a first extended reality zone, wherein the first extended reality zone comprises a first plurality of information boards configured to display virtual reality content, rendering a second extended reality zone adjacent to the first extended reality zone, wherein the second extended reality zone comprises a second plurality of information boards configured to display virtual reality content, providing a virtual barrier between the first extended reality zone and the second extended reality zone, wherein the virtual barrier prevents the user from virtually entering the second extended reality zone from the first extended reality zone, receiving, through an extended reality device, a progression input from the user, and removing the virtual barrier between the first extended reality zone and the second extended reality zone.

### FIELD OF DISCLOSURE

The disclosed embodiments generally relate to systems, devices, methods, and computer-readable media for an extended reality environment, and more particularly, for directing a user through an extended reality environment.

### BACKGROUND

Extended reality environments may provide realistic and immersive settings for sharing information. The improved processor speeds, data storage, and data transfer of extended reality devices, such as extended reality headsets, smart glasses, and other wearable extended reality apparatuses, may allow for hands-on collaboration and presentation of information, such as virtual information, among many users and in ways not possible in a purely physical environment. Nevertheless, as the use of extended reality environments becomes more prevalent in various settings (e.g., educational or professional), a challenge exists in providing an extended reality environment that is user-friendly and conducive to different purposes (e.g., learning).

### SUMMARY

In some examples, extended reality environments may enhance student learning by allowing for interactive education. Moreover, extended reality environments may allow people to share and explain concepts in a more immersive way than in a physical setting alone. Nevertheless, as mentioned above, a challenge exists in providing an extended reality environment that is user-friendly and conducive to different purposes (e.g., learning). For example, extended reality environments may virtually extend infinitely in all directions around a user. Such infinite extension of an extended reality environment may make it difficult for a user to organize information in the extended reality environment. This may lead to problems for a user, such as a student, trying to clearly navigate the extended reality environment to identify information that has already been presented or information that will be presented. Moreover, an over-display or over-generation of information may strain processing resources while providing minimal additional benefit to the user.

Therefore, to address these technical deficiencies in presenting an extended reality environment to a user, solutions for effectively and efficiently directing a user through an extended reality environment and moderating the amount of rendered content are desired. For example, and as discussed further herein, disclosed embodiments involve a first extended reality zone comprising a first plurality of information boards configured to display virtual reality content, a second extended reality zone adjacent to the first extended reality zone, wherein the second extended reality zone comprises a second plurality of information boards configured to display virtual reality content, and a virtual barrier between the first extended reality zone and the second extended reality zone, wherein the virtual barrier is configured to prevent a user from virtually moving between the first extended reality zone and the second extended reality zone unless a progression input is detected. As another example, and as discussed further herein, disclosed embodiments may also involve an extended reality environment that extends linearly along an axis in the extend reality environment. These solutions may allow a user to more easily organize and navigate an extended reality environment. In the context of a student using an extended reality environment for learning educational topics, the disclosed embodiments may provide easier and more efficient access to lesson information in the extended reality environment.

The disclosed embodiments describe a method for directing a user through an extended reality environment. For example, the method may comprise rendering a first extended reality zone, wherein the first extended reality zone comprises a first plurality of information boards configured to display virtual reality content, rendering a second extended reality zone adjacent to the first extended reality zone, wherein the second extended reality zone comprises a second plurality of information boards configured to display virtual reality content, providing a virtual barrier between the first extended reality zone and the second extended reality zone, wherein the virtual barrier prevents the user from virtually entering the second extended reality zone from the first extended reality zone, receiving, through an extended reality device, a progression input from the user, and removing the virtual barrier between the first extended reality zone and the second extended reality zone.

According to a disclosed embodiment, the method may further comprise receiving a content request input from the user, wherein the content request input comprises a request to display a third extended reality zone and inserting the third extended reality zone into the extended reality environment in response to the content request input.

According to a disclosed embodiment, inserting the third extended reality zone into the extended reality environment may comprise displaying the third extended reality zone adjacent to the second extended reality zone, and providing a virtual barrier between the second extended reality zone and the third extended reality zone.

According to a disclosed embodiment, inserting the third extended reality zone into the extended reality environment may comprise forming a virtual space between the first extended reality zone and the second extended reality zone, displaying the third extended reality zone in the virtual space formed between the first extended reality zone and the second extended reality zone, providing a first virtual barrier between the first extended reality zone and the third extended reality zone, and providing a second virtual barrier between the third extended reality zone and the second extended reality zone.

According to a disclosed embodiment, the first extended reality zone and the second extended reality zone may be rendered in a linear layout associated with an axis, and inserting the third extended reality zone into the extended reality environment may comprise rendering the third extended reality zone along the axis to maintain the linear layout.

According to a disclosed embodiment, providing a virtual barrier may comprise displaying a boundary line between the first extended reality zone and the second extended reality zone.

According to a disclosed embodiment, the first extended reality zone may further comprise a virtual reality character configured to interact with the user.

According to a disclosed embodiment, removing the virtual barrier may allow the user to virtually move from the first extended reality zone to the second extended reality zone.

According to a disclosed embodiment, the method may further include displaying a virtual interface in the extended reality environment, the virtual interface comprising at least one icon representing the first extended reality zone and the second extended reality zone, receiving a selection input from the user, the selection input comprising a selection of the second extended reality zone, and virtually moving the user to the second extended reality zone in response to receiving the selection input.

According to a disclosed embodiment, the method may further include receiving a movement input based on a hand gesture of the user, and displaying a movement of a virtual representation of the user in the extended reality environment in a direction of the second extended reality zone.

According to a disclosed embodiment, the method may further include comparing the progression input of the user to a predetermined threshold, and determining that the progression input of the user meets the predetermined threshold.

The disclosed embodiments may also describe an extended reality environment. For example, in an example, the extended reality environment may comprise a first extended reality zone comprising a first plurality of information boards configured to display virtual reality content, a second extended reality zone adjacent to the first extended reality zone, wherein the second extended reality zone comprises a second plurality of information boards configured to display virtual reality content, and a virtual barrier between the first extended reality zone and the second extended reality zone, wherein the virtual barrier is configured to prevent a user from virtually moving between the first extended reality zone and the second extended reality zone unless a progression input is detected.

According to a disclosed embodiment, the first plurality of information boards may comprise three information boards, and the second plurality of information boards comprises three information boards.

According to a disclosed embodiment, the virtual barrier may be represented in the extended reality environment by a line displayed between the first extended reality zone and the second extended reality zone.

According to a disclosed embodiment, the extended reality environment may further comprise a virtual character configured to interact with the user, wherein the virtual character may be rendered in at least one of the first extended reality zone or the second extended reality zone.

According to a disclosed embodiment, the virtual character may be associated with an artificial intelligence communication interface configured to receive a query from the user and provide answer data in response to the query.

According to a disclosed embodiment, the virtual character may be configured to play an audio output of a script to the user.

The disclosed embodiments also describe a system. For example, in an embodiment, the system may comprise at least one memory storing instructions, and at least one processor configured to execute the instructions to perform operations for directing a user through an extended reality environment. The operations may comprise rendering a first extended reality zone, wherein the first extended reality zone comprises a first plurality of information boards configured to display virtual reality content and at least one virtual reality object, rendering a second extended reality zone adjacent to the first extended reality zone, wherein the second extended reality zone comprises a second plurality of information boards configured to display virtual reality content and at least one virtual reality object, providing a virtual barrier between the first extended reality zone and the second extended reality zone, wherein the virtual barrier prevents the user from entering the second extended reality zone from the first extended reality zone, receiving, through the extended reality device, a progression input from the user, comparing the progression input of the user to a predetermined threshold, determining that the progression input of the user does not meet the predetermined threshold, and generating content in the first extended reality zone.

According to a disclosed embodiment, the operations may further comprise receiving a second progression input from the user, comparing the second progression input of the user to the predetermined threshold, determining that the second progression input of the user meets the predetermined threshold, and removing the virtual barrier between the first extended reality zone and the second extended reality zone.

According to a disclosed embodiment, the operations may further comprise displaying a virtual character configured to interact with the user in the first extended reality zone.

### BRIEF DESCRIPTION OF THE DRAWINGS

The accompanying drawings, which are incorporated in and constitute a part of this specification, illustrate several embodiments and, together with the description, serve to explain the disclosed principles. In the drawings:

FIG. 1A is a block diagram illustrating an exemplary operating environment for implementing various aspects of this disclosure, according to some embodiments of the present disclosure.

FIG. 1B is a block diagram illustrating an exemplary extended reality device for implementing various aspects of this disclosure, according to some embodiments of the present disclosure.

FIG. 2 is an illustration of an exemplary linear-based extended reality implementation, according to some embodiments of the present disclosure.

FIG. 3 is an enlarged illustration of an exemplary extended reality zone implementation, according to some embodiments of the present disclosure.

FIG. 4 is an illustration of an exemplary extended reality interaction area implementation, according to some embodiments of the present disclosure.

FIG. 5 is an illustration of an exemplary virtual interface displayed in an extended reality implementation, according to some embodiments of the present disclosure.

FIG. 6 is a flow diagram of an exemplary method for directing a user through an extended reality environment, according to some embodiments of the present disclosure.

### DETAILED DESCRIPTION

Exemplary embodiments are described with reference to the accompanying drawings. In the figures, the left-most digit(s) of a reference number identifies the figure in which the reference number first appears. Wherever convenient, the same reference numbers are used throughout the drawings to refer to the same or like parts. In the following detailed description, numerous specific details are set forth in order to provide a thorough understanding of the disclosed example embodiments. However, it will be understood by those skilled in the art that the principles of the example embodiments may be practiced without every specific detail. Well-known methods, procedures, and components have not been described in detail so as not to obscure the principles of the example embodiments. Unless explicitly stated, the example methods and processes described herein are neither constrained to a particular order or sequence nor constrained to a particular system configuration. Additionally, some of the described embodiments or elements thereof can occur or be performed (e.g., executed) simultaneously, at the same point in time, or concurrently. Reference will now be made in detail to the disclosed embodiments, examples of which are illustrated in the accompanying drawings.

It is to be understood that both the foregoing general description and the following detailed description are exemplary and explanatory only and are not restrictive of this disclosure. The accompanying drawings, which are incorporated in and constitute a part of this specification, illustrate several exemplary embodiments and together with the description, serve to outline principles of the exemplary embodiments.

This disclosure may be described in the general context of customized hardware capable of executing customized preloaded instructions such as, e.g., computer-executable instructions for performing program modules. Program modules may include one or more of routines, programs, objects, variables, commands, scripts, functions, applications, components, data structures, and so forth, which may perform particular tasks or implement particular abstract data types. The disclosed embodiments may also be practiced in distributed computing environments where tasks are performed by remote processing devices that are linked through a communications network. In a distributed computing environment, program modules may be located in local and/or remote computer storage media including memory storage devices.

The techniques for directing a user through an extended reality environment described herein overcome technological problems relating to providing an organized, clear, and user-friendly extended reality environment for a user. Existing extended reality environments may extend infinitely in all directions around a user, which may make it difficult for the user to navigate the extended reality environment. Further, such existing extended reality environments may require large amounts of computing resources to render the extended reality environment and virtual reality content infinitely in all directions. Moreover, many existing extended reality environments allow for broad access to the entire environment, when in many contexts it may be advantageous to limit, segment, sequence, or condition access to one or more virtual areas. The disclosed embodiments provide technical solutions to these and other problems arising from current techniques. For example, various disclosed embodiments include a method for directing a user through an extended reality environment. For example, the method may comprise rendering a first extended reality zone, rendering a second extended reality zone adjacent to the first extended reality zone, providing a virtual barrier between the first extended reality zone and the second extended reality zone, receiving, through an extended reality device, a progression input from the user, and removing the virtual barrier between the first extended reality zone and the second extended reality zone. Rendering extended reality zones along a linear axis may allow a user to more easily navigate the extended reality environment to access, view, and/or interact with content rendered in the extended reality environment. Rendering extended reality zones along a linear axis may also reduce computing resources needed to render the extended reality environment by rendering the extended reality zones and virtual reality content in an organized layout.

Reference will now be made in detail to the disclosed embodiments, examples of which are illustrated in the accompanying drawings. It should be noted that while some embodiments may refer to students or teachers, all of the disclosed embodiments may be used in other contexts as well, such as with any presenter and any audience or with a single user alone.

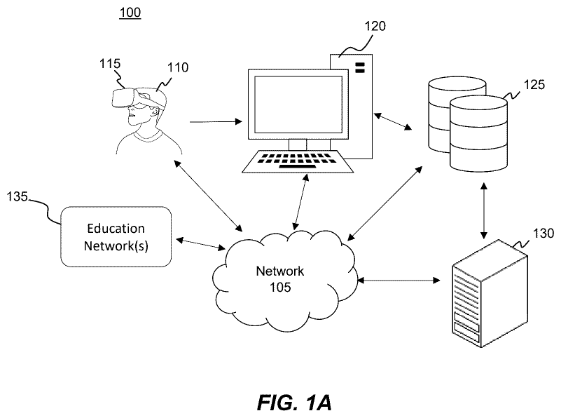

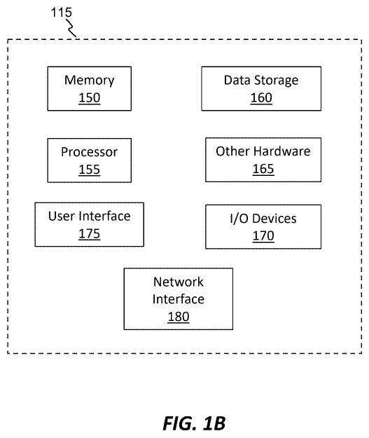

FIG. 1A illustrates an exemplary operating environment 100 for directing a user through an extended reality environment, consistent with the disclosed embodiments. Operating environment 100 may include one or more users 110 operating one or more extended reality devices 115, one or more computing devices 120, one or more databases 125, one or more servers 130, and one or more education network 135, as shown in FIG. 1A.

Operating environment 100 may include an extended reality system for displaying an extended reality environment. The term “extended reality environment,” which may also be referred to as “extended reality,” “extended reality space,” or “extended environment,” refers to all types of real-and-virtual combined environments and human-machine interactions at least partially generated by computer technology, including augmented reality environments. The extended reality environment may be a completely simulated virtual environment or a combined real-and-virtual environment that user 110 may perceive from different perspectives. In some examples, user 110 may interact with elements of the extended reality environment. One non-limiting example of an extended reality environment may be a virtual reality environment, also known as “virtual reality” or a “virtual environment.” An immersive virtual reality environment may be a simulated nonphysical environment which provides to the user 110 the perception of being present in the virtual environment. Another non-limiting example of an extended reality environment may involve a live direct or indirect view of a physical real-world environment that is enhanced with virtual computer-generated perceptual information, such as virtual objects that the user may interact with. Another non-limiting example of an extended reality environment is a mixed reality environment, also known as “mixed reality” or a “mixed environment.” A mixed reality environment (e.g., an augmented reality environment) may be a hybrid of physical real-world and virtual environments, in which physical and virtual objects may coexist and interact in real time. In some examples, both extended reality environments and mixed reality environments may include a combination of real and virtual worlds, real-time interactions, and accurate 3D registration of virtual and real objects. In some examples, both extended reality environments and mixed reality environments may include constructive overlaid sensory information that may be added to the physical environment. In other examples, both extended reality environment and mixed reality environments may include destructive virtual content that may mask at least part of the physical environment.

Operating environment 100 may include at least one extended reality device 115 which may be operated or worn by a user 110. Extended reality device 115 may include any type of device or system that enables a user, such as user 110, to perceive and/or interact with an extended reality environment. Extended reality device 115 may enable user 110 to perceive and/or interact with an extended reality environment through one or more sensory modalities. Some non-limiting examples of such sensory modalities may include visual, auditory, haptic, somatosensory, and olfactory. Consistent with one aspect of the disclosure, the extended reality device 115 may be a wearable device, such as a head-mounted device, for example, smart glasses, smart contact lens, extended reality devices (e.g., the Meta Quest Pro, Apple Vision Pro, HTC VIVE, Oculus, Valve Index) or any other device worn by user 110 for purposes of presenting an extended reality to the user 110. Other extended reality devices 115 may include a holographic projector or any other device or system capable of providing an extended reality, virtual reality, mixed reality, or any immersive experience. Components of wearable extended reality devices 115 may include at least one of: a stereoscopic head-mounted display, a stereoscopic head-mounted sound system, head-motion tracking sensors (such as gyroscopes, accelerometers, magnetometers, image sensors, structured light sensors, etc.), head mounted projectors, eye-tracking sensors, and additional components described below. Consistent with another aspect of the disclosure, the extended reality device 115 may be a nonwearable extended reality device, which may include multi-projected environment devices. In some embodiments, an extended reality device 115 may be configured to change the viewing perspective of the extended reality environment in response to movements of the user 110 and in response to head movements of the user 110 in particular. In one example, a wearable extended reality device 115 may change the field-of-view of the extended reality environment in response to a change of the head pose of the user 110, such as by changing the spatial orientation without changing the spatial position of the user 110 in the extended reality environment. In other embodiments, extended reality device 115 may be configured to change the viewing perspective of the extended reality environment in response to eye movements of the user, based on eye-tracking sensors integrated with extended reality device 115. For example, extended reality device 115 may change the field-of-view of the extended reality environment in response to eye movements of the user, such as by changing the spatial orientation without changing the spatial position of the user 110 in the extended reality environment.

The various devices, systems, and/or components of operating environment 100 may communicate over a network 105, which may include at least one of the Internet, a wired Wide Area Network (WAN), a wired Local Area Network (LAN), a wireless WAN (e.g., WiMAX), a wireless LAN (e.g., IEEE 802.11, etc.), a mesh network, a mobile/cellular network, an enterprise or private data network, a storage area network, a virtual private network using a public network, a nearfield communications technique (e.g., Bluetooth, infrared, etc.), or any electronic communication architecture. In some embodiments, the communications may take place across two or more of these forms of networks and their corresponding protocols. While operating environment 100 is shown as a network-based environment, it is understood that the disclosed systems and methods may also be used in a localized system, with one or more of the components communicating directly with each other.

Computing devices 120 may be a variety of different types of computing devices capable of developing, storing, analyzing, and/or executing software code. For example, computing device 120 may be a personal computer (e.g., a desktop or laptop), an IoT device (e.g., sensor, smart home appliance, connected vehicle, etc.), a server, a mainframe, a vehicle-based or aircraft-based computer, a virtual machine (e.g., virtualized computer, container instance, etc.), or the like. Computing device 120 may be a handheld device (e.g., a mobile phone, a tablet, or a notebook), a wearable device (e.g., a smart watch, smart jewelry, an implantable device, a fitness tracker, smart clothing, a head-mounted display, etc.), an IoT device (e.g., smart home devices, industrial devices, etc.), or various other devices capable of processing and/or receiving data. Computing device 120 may operate using a Windows™ operating system, a terminal-based (e.g., Unix or Linux) operating system, a cloud-based operating system (e.g., through AWS™, Azure™, IBM Cloud™, etc.), or other types of non-terminal operating systems.

Operating environment 100 may further include one or more database(s) 125, which may store and/or execute software. For example, database 125 may be configured to store software or code, such as code developed using computing device 120. Database 125 may further be accessed by computing device 120, server 130, or other components of operating environment 100 for downloading, receiving, processing, editing, or running the stored software or code. Database 125 may be any suitable combination of data storage devices, which may optionally include any type or combination of databases, load balancers, dummy servers, firewalls, back-up databases, and/or any other desired database components. In some embodiments, database 125 may be employed as a cloud service, such as a Software as a Service (SaaS) system, a Platform as a Service (PaaS), or Infrastructure as a Service (IaaS) system. For example, database 125 may be based on infrastructure or services of Amazon Web Services™ (AWS™), Microsoft Azure™, Google Cloud Platform™, Cisco Metapod™, Joyent™, vmWare™, or other cloud computing providers. Database 125 may be configured to use a data sharing platform, which may include other commercial file sharing services, such as Dropbox™, Google Docs™, or iCloud™. In some embodiments, database 125 may be a remote storage location, such as a network drive or server in communication with network 105. In other embodiments database 125 may also be a local storage device, such as local memory of one or more computing devices (e.g., computing device 120) in a distributed computing environment.

Operating environment 100 may also comprise one or more server device(s) 130 in communication with network 105. Server 130 may manage the various components in operating environment 100. In some embodiments, server 130 may be configured to process and manage requests between computing devices 120 and/or databases 125. Server 130 may identify updates to code in database 125, may receive updates when new or revised code is entered in database 125, and may participate in directing a user through an extended reality environment.

Operating environment 100 may also comprise one or more education networks 135. Education networks 135 may provide a variety of tools and resources that may be incorporated by user 110 into the extended reality environment displayed by extended reality device 115. For example, education network 135, which may include one or more storage devices (not explicitly depicted), may provide backgrounds of an extended reality environment, an appearance of avatars in an extended reality object, a room in which instruction may take place, or any virtual reality objects that may be used, rendered, or generated in an extended reality environment. User 110 may access education network 135 while using extended reality device 115 through network 105 to develop and display an educational virtual or extended reality environment for instructing students.

FIG. 1B is a block diagram of an exemplary extended reality device 115 for implementing various aspects of the present disclosure. As illustrated in FIG. 1B, components of extended reality device 115 may include, but are not limited to, various hardware components, such as a system memory 150, at least one logical processor 155, data storage 160, other hardware 165, one or more input/output (I/O) devices 170, a user interface 175, a network interface 180, and a system bus (not shown) that couples (e.g., communicably couples, physically couples, and/or electrically couples) various system components such that the components may transmit data to and from one another. The system bus may be any of several types of bus structures including a memory bus or memory controller, a peripheral bus, and a local bus using any of a variety of bus architectures. By way of example, and not limitation, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Extended reality device 115 may include at least one logical processor 155. The at least one logical processor 155 may include circuitry and transistors configured to execute instructions from at least one memory (e.g., memory 150). For example, the at least one logical processor 155 may include one or more central processing units (CPUs), arithmetic logic units (ALUs), Floating Point Units (FPUs), and/or Graphics Processing Units (GPUs). The extended reality device 115, like other suitable devices, may also include one or more computer-readable storage media, which may include, but are not limited to, memory 150 and data storage 160. In some embodiments, memory 150 and data storage 160 may be part of a single memory component. The one or more computer-readable storage media may also be of different physical types. The media may be volatile memory, non-volatile memory, fixed in place media, removable media, magnetic media, optical media, solid-state media, and/or of other types of physical durable storage media (as opposed to merely a propagated signal). Some other examples of computer-readable storage media may include built-in random access memory (RAM), read-only memory (ROM), hard disks, and other memory storage devices which are not readily removable by users (e.g., memory 150).

The data storage 160 or system memory 150 may include computer storage media in the form of volatile and/or nonvolatile memory such as ROM and RAM. A basic input/output system (BIOS), containing the basic routines that help to transfer information between elements within extended reality device 115, such as during start-up, may be stored in ROM. RAM may contain data and/or program modules that are immediately accessible to and/or presently being operated on by processing unit. By way of example, and not limitation, data storage 160 may hold an operating system, application programs, and other program modules and program data.

Data storage 160 may also include other removable/non-removable, volatile/nonvolatile computer storage media. By way of example only, data storage 160 may be a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like.

Although an embodiment may be described as being implemented as software instructions executed by one or more processors in a computing device (e.g., general-purpose computer, server, or cluster) or an extended reality device, such description is not meant to exhaust all possible embodiments. One of skill will understand that the same or similar functionality can also often be implemented, in whole or in part, directly in hardware logic, to provide the same or similar technical effects. Alternatively, or in addition to software implementation, the technical functionality described herein can be performed, at least in part, by one or more hardware logic components. For example, and without excluding other implementations, an embodiment may include other hardware logic components such as Field-Programmable Gate Arrays (FPGAs), Application-Specific Integrated Circuits (ASICs), Application-Specific Standard Products (ASSPs), System-on-a-Chip components (SOCs), Complex Programmable Logic Devices (CPLDs), and similar components. Components of an embodiment may be grouped into interacting functional modules based on their inputs, outputs, and/or their technical effects, for example.

In addition to processor(s) 155, memory 150, data storage 160, and screens/displays, an operating environment may also include other hardware 165, such as batteries, buses, power supplies, wired and wireless network interface cards, for instance. In some embodiment, input/output (I/O) devices 170 such as human user input/output devices (screen, keyboard, mouse, tablet, microphone, speaker, motion sensor, etc.) may be present in operable communication with one or more processors 155 and memory 150. A user such as user 110 may interact with the extended reality environment through extended reality device 115 by using one or more I/O device 170, such as a display, keyboard, mouse, microphone, touchpad, camera, sensor (e.g., touch sensor) and other devices, via typed text, touch, voice, movement, computer vision, gestures, and/or other forms of input/output.

Extended reality device 115 may further be configured to present at least one user interface 175. A user interface 175 may support interaction between an embodiment and user 110. A user interface 175 may include one or more of a command line interface, a graphical user interface (GUI), natural user interface (NUI), voice command interface, and/or other user interface (UI) presentations, which may be presented as distinct options or may be integrated. A user may enter commands and information through a user interface 175 or other I/O devices 170 such as a tablet, electronic digitizer, a microphone, keyboard, and/or pointing device, commonly referred to as mouse, trackball or touch pad. Other input devices may include a joystick, game pad, game controller, wand, satellite dish, scanner, or the like. In some embodiments, at least one I/O device 170 may exist separately from extended reality device 115 and may be communicably coupled (e.g., through a wired connection, wireless connection) to extended reality device 115. Additionally, voice inputs, gesture inputs using hands or fingers, or other NUI may also be used with the appropriate input devices, such as a microphone, camera, tablet, touch pad, glove, or other sensor. These and other input devices are often connected to the processing units through a user input interface that is coupled to the system bus, but may be connected by other interface and bus structures, such as a parallel port, game port or a universal serial bus (USB). User interface 175 may include one or more toggles or controls which a user can interact with or operate. In some embodiments, the extended reality environment displayed by extended reality device 115 may change based on (e.g., in response to, derived from, dependent upon) interactions with the user interface 175. For example, the extended reality environment may change based on an interaction with a button, control, icon, or toggle displayed in the user interface 175. An interaction with user interface 175 may include gestures such as hovers, clicks, long presses, or the like, and interactions may be executed by a user in some examples.

Other computerized devices and/or systems not shown in FIG. 1B may interact (e.g., communicate electronically) with extended reality device 115 or with another system using one or more connections to a network, such as network 105, via a network interface 180, which may include network interface equipment, such as a physical network interface controller (NIC) or a virtual network interface (VIF).

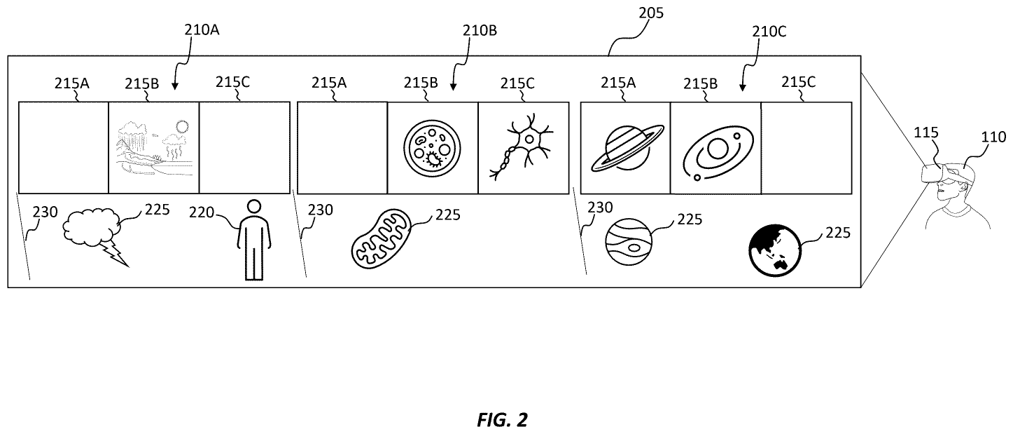

FIG. 2 depicts an embodiment of an extended reality implementation. User 110 may wear or otherwise operate an extended reality device, such as extended reality device 115. Extended reality device 115 may display extended reality environment 205 (e.g., on one or more screens, such as in a headset). In some embodiments, extended reality environment 205 may comprise a live direct view of the physical environment of user 110 that is enhanced with virtual, computer-generated perceptual information. In other embodiments, extended reality environment 205 may comprise a view of a rendering and/or display of a virtual reality environment, which may not allow user 110 to view the physical environment. Extended reality environment 205 may include virtual user rendering 220. Virtual user rendering 220 may include a visual representation of user 110 within extended reality environment 205. Virtual user rendering 220 may allow for and/or visualize (e.g., animate within extended reality environment 205) virtual interactions of user 110 with components in extended reality environment 205.

As depicted in FIG. 2, extended reality environment 205 may be divided into a linear set of zones 210A, 210B, and 210C (210A-210C), which may be virtually separated by virtual barriers 230. Although FIG. 2 depicts three zones 210A-210C, extended reality environment 205 may include any number of zones, which may extend (e.g., infinitely) along a linear axis. Zones 210A-210C may comprise specifically delineated areas within extended reality environment 205 in which user 110 (through virtual user rendering 220) may virtually move (e.g., by updating a field-of-view of extended reality environment 205 in response to a change of the head pose of user 110, a gesture of user 110, or movement of user 110 in the physical environment). In some embodiments, a device associated with rendering an extended reality environment may maintain a correspondence (e.g., using coordinates) between one or more real-world areas and one or more virtual areas (e.g., zones). Virtually moving may include changing a viewpoint within an extended reality environment, changing displayed content, generating content for display, removing displayed content, and/or animating virtual content. Virtually moving may be based on (e.g., performed in response to, dependent upon, according to) a user interaction, such as a gesture (e.g., arm and/or hand movements), input to an input device, or user movement (e.g., turning of a head, walking). Each of zones 210A-210C may be separated by virtual barriers 230. A virtual barrier may include digital information (e.g., one or more of computerized code, coordinates of an extended reality environment, pixel locations, a user location, a user rendering location, a zone location, a zone dimension) configured to prevent user 110 from virtually moving into different zones (e.g., from viewing content associated with one or more zones, from positioning a viewpoint from within one or more zones). For example, virtual barrier 230 may prevent user 110 (through virtual user rendering 220) from virtually moving from zone 210A to zone 210B (e.g., by preventing viewing of content in zone 210B and/or preventing a viewpoint from zone 210B). If user 110 (through virtual user rendering 220) virtually approaches virtual barrier 230, then the field-of-view for user 110 within extended reality environment 205 may not update in response to movements and/or gestures by user 110 in the physical environment, such that user 110 is prevented from virtually moving between zones 210A-210C. In some embodiments, virtual barriers 230 may be associated with a line or wall rendered between each of zones 210A-210C rendered in extended reality environment 205. In other embodiments, virtual barriers 230 between each of zones 210A-210C may not be visible to user 110.

Zones 210A-210C may extend linearly along an axis and each of zones 210A-210C may contain differing extended reality content with which user 110 may virtually interact (e.g., move, re-size, change, cause to emit sound and/or motion). Each of zones 210A-210C may comprise one or more information boards, such as information boards 215A, 215B, and 215C (215A-215C). In some embodiments, information boards 215A-215C may include and/or display a virtual rendering of a whiteboard, chalkboard, blackboard, smart board, or the like. In other embodiments, information boards 215A-215C may include and/or display virtual reality content such as pictures, videos, documents, assignments, text book pages, presentations, equations, or the like. Information boards 215A-215C may display animate virtual reality content (e.g., continually animate virtual reality content or partially animate virtual reality content that animates based on a combination of one or more user interactions) or inanimate virtual reality content. Information boards 215A-215C may be rendered to each virtually extend 6 feet in extended reality environment 205. In other embodiments, information boards 215A-215C may each be rendered to extend more or less than 6 feet in extended reality environment 205 (e.g., 2-20 feet). User 110 may visually observe content displayed on information boards 215A-215C and/or may interact with information boards 215A-215C through a gesture-based interaction (e.g., detectable by a motion sensor or other component of extended reality device 115) and/or through interacting with a keyboard, a mouse, or any other input/output devices (e.g., any of input/output devices 170) configured to allow user interaction with information boards 215A-215C. In other embodiments, an interaction with information boards 215A-215C may include one or more gestures such as pointing actions, grabbing actions, holding actions, dragging actions, hovers, clicks, long presses, or the like. In some embodiments, as depicted in FIG. 2, zones 210A-210C may comprise three information boards 215A-215C. In other embodiments, zones 210A-210C may comprise more or fewer information boards.

Each of zones 210A-210C may also include extended reality objects 225. In some embodiments, extended reality objects 225 may comprise at least one of a three-dimensional object, a two-dimensional object (e.g., a page or an interface), a recording, or a text display. Additionally or alternatively, extended reality objects 225 may comprise at least one of inanimate virtual content, animate virtual content configured to change over time or in response to triggers, virtual two-dimensional content, virtual three-dimensional content, a virtual overlay over a portion of a physical environment or over a physical object (e.g., in an augmented reality environment), a virtual addition to a physical environment or to a physical object (e.g., in an augmented reality environment), a virtual representation of a physical object, a virtual representation of a physical environment, a virtual document, a virtual character or persona, a virtual computer screen, a virtual widget, or any other format for displaying information (e.g., educational information) virtually. Each of zones 210A-210C may contain any number of extended reality objects 225.

Virtual barriers 230 may prevent user 110 from virtually moving (through user rendering 220) from zone 210A to zone 210B or zone 210C. However, virtual barriers 230 may be removed between zones 210A-210C as user 110 progresses through each of zones 210A-210C, as disclosed herein with respect to process 600. Progressing through a zone may include completing a combination of one or more objectives (e.g., within and/or by using an extended reality environment), such as at least one of one or more tasks, one or more assignments, one or more quizzes, one or more milestones, or any other project in zone 210A which may allow user rendering 220 to virtually move to zone 210B. In some embodiments, one or more objectives may be associated with a particular score or other indicator of proficiency, such that an objective is not considered complete until it is completed with at least a threshold score. Each of zones 210A-210C may contain virtual reality content related to a similar topic, such as an educational course, or may contain virtual reality content related to different topics, such as a variety of educational courses.

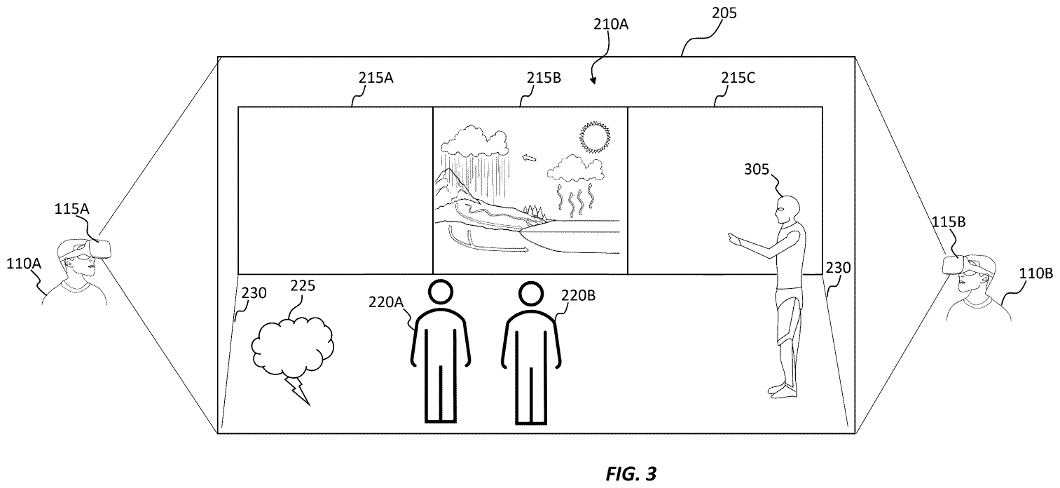

FIG. 3 depicts an enlarged view of zone 210A in extended reality environment 205, viewable by user 110A through extended reality device 115A and by user 110B through extended reality device 115B. Zone 210A may contain information boards 215A-215C and extended reality objects 225, as disclosed herein with respect to FIG. 2. In some embodiments, as depicted in FIG. 3, multiple users, such as user 220A and user 220B, may simultaneously view and interact with extended reality environment 205 through extended reality device 115A and extended reality device 115B, respectively. In such embodiments, extended reality environment 205 may include virtual user rendering 220A and virtual user rendering 220B. Virtual user rendering 220A may virtually represent user 110A in extended reality environment 205 and virtual user rendering 220B may virtually represent user 110B in extended reality environment 205. In some embodiments, as depicted in FIG. 3, user 110A (through virtual user rendering 220A) and user 110B (through virtual user rendering 220B) may be virtually located in the same zone 210A. In other embodiments, user 110A and user 110B may be virtually located in different zones. In some embodiments, more or fewer users may participate in extended reality environment 205 and may be located in any zone in extended reality environment 205. In some embodiments, the same content may be displayed to all users in a same extended reality environment. Alternatively, the same content may be displayed to some users in a same extended reality environment and different content may be displayed to other users in the same extended reality environment. As yet another alternative, different content (e.g., different in at least one aspect) may be displayed to each user in the same extended reality environment. While certain aspects discussed herein may be described with respect to only user 110A and/or user 110B, it is appreciated that such aspects may cause corresponding actions by user rendering 220A and/or user rendering 220B (e.g., cause user rendering 220A and/or user rendering 220B to copy, mimic, or indicate an action by user 110A and/or user 110B). Similarly, while certain aspects discussed herein may be described with respect to only user rendering 220A and/or user rendering 220B, it is appreciated that such aspects may correspond to an initial action (e.g., a similar action, a same action, an action mimicked by user rendering 220A and/or user rendering 220B) by user 110A and/or user 110B.

Extended reality environment 205 may also include at least one virtual character 305. Virtual character 305 may be associated with an artificial intelligence communication interface that may be configured to receive a query from the user and provide answer data in response to the query. For example, virtual character 305 may be a simulated representation of, and/or an interface with, a machine learning model (e.g., a model hosted or run by an extended reality device 115, computing device 120, a databases 125, or a server 130) and may be configured as a non-player character (e.g., avatar) and/or an interface for simulating human interaction, such as a computerized text-to-chat model. For example, virtual character 305 may receive one or more prompts such as a question from user 110A or user 110B through at least one input (e.g., auditory input, tactile input, text input, gesture input, etc.) and virtual character 305 may receive, display, use, and/or generate responsive data using one or more machine learning models, as described herein. Virtual character 305 may be configured to interact with user rendering 220A and/or user rendering 220B through audio (e.g., conversing via speech and hearing), or through a visual display. In some examples, extended reality environment 205 may be configured for interactions between a user and/or user rendering and virtual character 305, including interactions where virtual character 305 receives a prompt from user rendering 220A and/or user rendering 220B, such that extended reality environment 205 may generate answer data corresponding to the prompt. For example, virtual character 305 may be a communication interface with a machine learning model (e.g., an artificial intelligence language model), may transmit one or more received prompts to the machine learning model, receive answer data (e.g., from the machine learning model) based on the one or more prompts, and/or may convert received answer data into a format (e.g., responsive data) that can be output to a user in an extended reality environment (e.g., computer-generated speech). In some embodiments, user rendering 220A or user rendering 220B may animate based on interactions (e.g., movements, gestures, button presses) from user 110A or user 110B, respectively.

In some embodiments, virtual character 305 may be configured to animate and/or provide an audio output, which may correspond to a script, to user 110A and/or user 110B. For example, virtual character 305 may be configured to provide an audio output of at least one of an introductory script, a script explaining the virtual objects 225 and/or information provided on information boards 215A-215C, a script explaining an assignment or task for user 110A and/or user 110B to complete, or any other scripts. In some embodiments, virtual character 305 may begin providing the audio output of a script when (e.g., in response to, based on determining) user 110A and/or user 110B (through user rendering 220A and/or user rendering 220B, respectively) virtually enter zone 210A, when (e.g., in response to, based on determining) user 110A and/or user 110B are virtually located within a predetermined proximity of virtual character 305, or when (e.g., in response to, based on determining) user 110A and/or 110B provide a gesture or audio input through extended reality device 115A and/or extended reality device 115B. When user 110A and/or user 110B move to a different zone, such as zone 210B or zone 210C as depicted in FIG. 2, virtual character 305 may be rendered in such zone to interact with user 110A and/or user 110B. In some embodiments, virtual character 305 may not be rendered and may not be accessible to users in particular zones. For example, if user 110A and/or user 110B are virtually participating in a quiz (or other extended reality activity) in zone 210A, then virtual character 305 may not be rendered in zone 210A and may not be accessible to user 110A and/or user 110B so that user 110A and/or user 110B cannot virtually ask questions to virtual character 305 about the quiz.

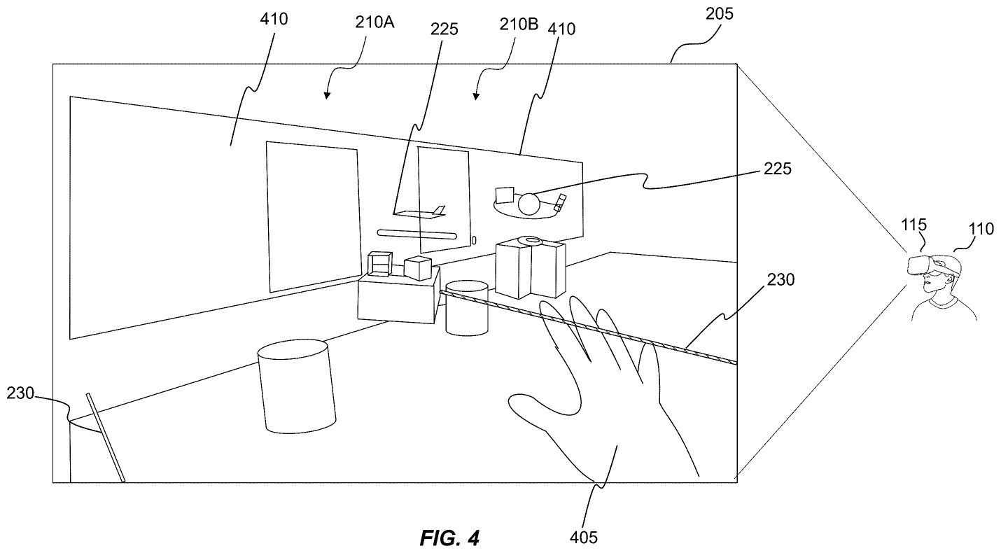

FIG. 4 depicts a view of extended reality environment 205, in accordance with disclosed embodiments. As depicted in FIG. 4, extended reality environment 205 may include zones 210A and 210B which may extend along a linear axis. In other embodiments, extended reality environment 205 may include more or fewer zones and may include zones that may extend infinitely along the linear axis. Each of zones 210A and 210B may include information boards 410, which may correspond to information boards 215A-215C, as disclosed herein with respect to FIG. 2 and FIG. 3. As depicted in FIG. 3, information boards 410 may display a static, two-dimensional image of an assignment or a task for user 110. Additionally or alternatively, information boards 410 may display at least one of one or more videos, one or more animations, one or more pictures, one or more text, or one or more other visual renderings that may be view by user 110. Each of zones 210A and 210B may further include virtual reality objects 225. In some embodiments, as depicted in FIG. 3, a virtual barrier 230 may be provided between zone 210A and zone 210B. Virtual barrier 230 may be, and/or be represented by, a line rendered and/or displayed between zone 210A and zone 210B. User 110 may be prevented from virtually moving between zone 210A and zone 210B by virtual barrier 230. In some embodiments, user 110 may be permitted to virtually move between zone 210A and zone 210B after completing an assignment or a task in zone 210A.

User 110 may have a “first-person” perspective in extended reality environment 205, meaning that the rendering of extended reality environment 205 through extended reality device 115 may appear to user 110 as if user 110 is within extended reality environment 205. For example, extended reality environment 205 may include hand rendering 405. The location, movements, and gestures of hand rendering 405 may correspond to the location, movements, and gestures of the hand of user 110 in the physical environment. A hand rendering 405 may be based on at least one of a visual detection of a hand of user 110 (e.g., by at least one camera) or at least one sensor in a glove, controller, joystick, or other handheld or hand-worn object.

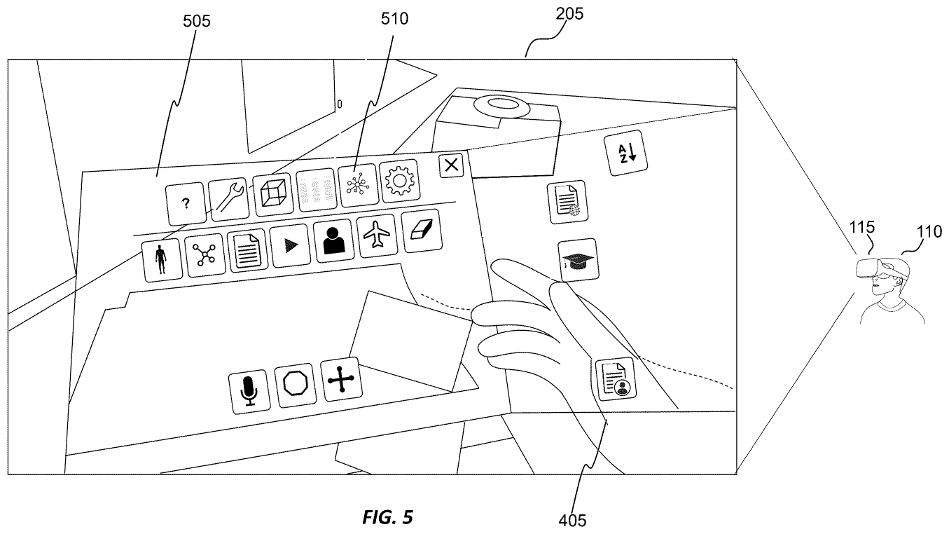

FIG. 5 depicts virtual interface 505 within extended reality environment 205. User 110 may access virtual interface 505 through specific gestures or audio inputs. Virtual interface 505 may allow user 110 to change a view or a perspective of extended reality environment 205, render new virtual reality objects, view new or different videos, pictures, or other media, move between zones, perform an objective, and/or interact with other users or virtual characters, among other functions. For example, virtual interface 505 may include a plurality of icons 510. Icons 510 may correspond to sub-menus, which may be virtual interfaces of additional options for selection by user 110 based on specific categories. User 110 may select icons 510 through a physical gesture that may correspond to a virtual rendering of hand rendering 405 selecting one of icons 510.

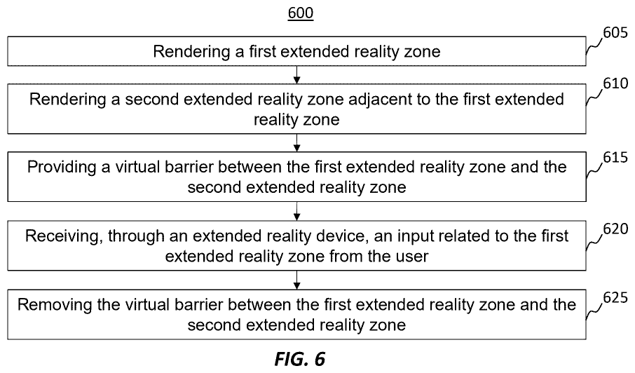

FIG. 6 displays a process 600 for directing a user, such as user 110, through at least a portion of an extended reality environment, such as extended reality environment 205. In accordance with disclosed embodiments, process 600 may be implemented by extended reality device 115 depicted in FIG. 1A, or any type of extended reality environment. For example, process 600 may be performed by at least one processor (e.g., processor 155), memory (e.g., memory 150), and/or other components of extended reality device 115, or by any computing device. In some embodiments, different parts of process 600 may be performed by different devices. Although FIG. 6 shows example blocks of process 600, in some implementations, process 600 may include additional blocks, fewer blocks, repeated blocks, different blocks, or differently arranged blocks than those depicted in FIG. 6. Additionally, or alternatively, two or more of the blocks of process 600 may be performed in parallel.

Step 605 of process 600 may include rendering a first extended reality zone. In some embodiments, the first extended reality zone may correspond to one of zones 210A-210C, as disclosed herein with respect to FIGS. 2-4. For example, a first extended reality zone may comprise a virtually defined space (e.g., two-dimensional or three-dimensional extended reality space) within which a user, such as user 110, may virtually move (which may correspond to a physical space, as discussed above). Rendering a first extended reality zone may comprise displaying images (e.g., sensory images) that represent an extended reality environment, such as extended reality environment 205. For example, rendering a first extended reality zone may include producing and displaying images of an extended reality environment such that the images are perceived as a continuous flow, rather than individual images. Geometric models, rigid body transformations, and viewpoint transformations may be used to determine where objects in an extended reality environment should appear when displayed through an extended reality device. Light propagation, visual physiology, and visual perception may also be used to determine how virtual reality objects should appear in an extended reality environment so that the extended reality environment appears realistic and maintains continuity for a user. Rendering a first extended reality zone may comprise displaying, through an extended reality device to a user, the first extended reality zone so that a user may smoothly and continuously interpret and interact with the extended reality zone.

The first extended reality zone may comprise a first plurality of information boards configured to display virtual reality content. The first plurality of information boards may correspond to information boards 215A-215C, as disclosed herein with respect to FIGS. 2-4. For example, information boards may include a virtual rendering of a whiteboard, chalkboard, blackboard, smart board, or the like. In other embodiments, information boards may display virtual reality content such as pictures, videos, documents, or other forms of media. Information boards may display animate or inanimate virtual reality content, as discussed above. In some embodiments, information boards may be rendered to each virtually extend a particular distance (e.g., 6 feet) in the extended reality environment, as discussed above. A user may visually observe content displayed on information boards and/or may interact with information boards through a gesture-based interaction (e.g., detectable by a motion sensor or other component of an extended reality device) and/or through a keyboard, a mouse, or any other input/output devices (e.g., any of input/output devices 170) configured to allow user interaction with information boards. In other embodiments, an interaction with information boards may include one or more gestures such as pointing actions, grabbing actions, holding actions, hovers, clicks, long presses, or the like.

Step 610 of process 600 may include displaying a second extended reality zone adjacent to the first extended reality zone. The second extended reality zone may correspond to one of zones 210A-210C, as disclosed herein with respect to FIGS. 2-4. For example, a second extended reality zone may comprise a virtually defined space within which a user, such as user 110, may virtually move. Rendering the second extended reality zone may correspond to rendering the first extended reality zone, as disclosed herein with respect to Step 605 of process 600. For example, rendering a first extended reality zone may comprise displaying sensory images that represent an extended reality environment, such as extended reality environment 205. Rendering a first extended reality zone may comprise displaying, through an extended reality device to a user, the first extended reality zone so that a user may smoothly and continuously interact with the extended reality zone.

In some embodiments, the second extended reality zone may be rendered with different content than the first extended reality zone, but may also be rendered with the same or similar types of content (e.g., information boards) as the first extended reality zone. For example, the second extended reality zone may comprise a second plurality of information boards configured to display virtual reality content (e.g., differing from virtual reality content displayed on one or more information boards in the first extended reality zone). The second plurality of information boards may correspond to information boards 215A-215C, as disclosed herein with respect to FIGS. 2-4. For example, information boards may include a virtual rendering of a whiteboard, chalkboard, blackboard, smart board, or the like. In other embodiments, information boards may display virtual reality content such as pictures, videos, documents, or other forms of media. Information boards may display animate or inanimate virtual reality content. In some embodiments, information boards may be rendered to each virtually extend 6 feet in the extended reality environment. In other embodiments, information boards may each be rendered to extend more or less than 6 feet in the extended reality environment. A user may visually observe content displayed on information boards and/or may interact with information boards through a gesture-based interaction (e.g., detectable by a motion sensor or other component of an extended reality device) and/or through a keyboard, a mouse, or any other input/output devices (e.g., any of input/output devices) configured to allow user interaction with information boards. In other embodiments, an interaction with information boards may include one or more gestures such as pointing actions, grabbing actions, holding actions, hovers, clicks, long presses, or the like.

In some embodiments, the first extended reality zone and the second extended reality zone may display virtual reality content associated with at least one of a lesson plan, an educational course, a tutoring session, or any other educational content. In some embodiments, the first extended reality zone may display virtual reality content associated with a first section of a lesson plan or educational course and the second extended reality zone may display virtual reality content associated with a second section of a lesson plan or educational course. In other embodiments, the first extended reality zone may display virtual reality content associated with a first educational topic and the second extended reality zone may display virtual reality content associated with a second, distinct educational topic.

Step 615 of process 600 may include providing a virtual barrier between the first extended reality zone and the second extended reality zone. A virtual barrier may prevent a user from virtually entering the second extended reality zone from the first extended reality zone. In some embodiments, the virtual barrier may correspond to virtual barrier 230 as disclosed herein with respect to FIG. 2. In some embodiments, providing a virtual barrier may comprise displaying a boundary line between the first extended reality environment and the second extended reality environment. For example, the virtual barrier may be rendered and/or displayed as a line or a wall between the first extended reality zone and the second extended reality zone so that a user can visually see a boundary between the first extended reality zone and the second extended reality zone. In other embodiments, the virtual barrier may not be rendered or displayed between the first extended reality zone and the second extended reality zone. In such embodiments, the user may not see the virtual barrier rendered in the extended reality environment, but may still be prevented from moving between the first extended reality zone and the second extended reality zone by the virtual barrier and/or prevented from viewing content within the first or second extended reality zone.

In some embodiments, the virtual barrier may prevent a user from virtually entering the second extended reality zone from the first extended reality zone. For example, if a user (through a virtual user rendering) virtually approaches the virtual barrier, then the field-of-view for the user within extended reality environment may not update in response to movements and/or gestures by user in the physical environment, such that user is prevented from virtually moving between zones. Preventing the user from virtually entering the second extended reality zone may further include preventing a display of viewing angles of the second plurality of information boards from within the second extended reality zone. When a user virtually approaches the virtual barrier, the extended reality device may render a view of the extended reality environment in which the user is adjacent to the virtual barrier, but will not render a view of the user in the second extended reality environment.

Step 620 of process 600 may include receiving, through an extended reality device, a progression input related to the first extended reality zone from the user. Receiving a progression input may comprise receiving a gesture-based interaction (e.g., detectable by a motion sensor or other component of extended reality device 115) and/or an interaction through a keyboard, a mouse, or any other input/output devices (e.g., any of input/output devices 170) configured to allow user interaction with the first extended reality zone. In other embodiments, an interaction with the first extended reality zone may include one or more gestures such as pointing actions, grabbing actions, holding actions, hovers, clicks, long presses, or the like. Additionally, voice inputs, gesture inputs using hands or fingers, or other NUI may also be used with the appropriate input devices, such as a microphone, camera, tablet, touch pad, glove, or other sensor. In some embodiments, a progression input may include a combination of multiple user inputs and/or other conditions (e.g., prior interactions, objectives, scores, etc.).

In some embodiments, the progression input associated with the first extended reality zone may comprise an input based on (e.g., in response to) an educational activity or assignment in the first extended reality zone. For example, the first extended reality zone may render and/or display a question, a task, an assignment, a quiz, or any other educational activity that may assess a user's understanding of material being presented through the first extended reality zone. The progression input associated with the first extended reality zone may comprise an answer to a question, an assignment, or a quiz. Additionally or alternatively, the progression input may comprise a minimum score associated with an activity (e.g., quiz, test, or other assessment). In other embodiments, the progression input associated with the first extended reality zone may comprise a completion of a task in the first extended reality zone, such as watching a video displayed in the first extended reality zone, listening to a lecture presented through the first extended reality zone, or any other educational task that may be presented through the first extended reality zone.

In some embodiments, process 600 may include comparing the progression input of the user to a predetermined threshold and determining that the progression input of the user meets the predetermined threshold. In some embodiments, the predetermined threshold may comprise a correct answer to a question, a number of correct answers that must be provided to a plurality of questions, a completion of a task or assignment, or any other threshold that the progression input may be compared to. For example, the first extended reality zone may include a task with a plurality of questions and the predetermined threshold may comprise a minimum number of correct answers that the user must select. In another example, the first extended reality zone may include a video and the predetermined threshold may comprise a minimum amount of the video that the user must view. Process 600 may compare the progression input of the user to the predetermined threshold and may automatically determine that the user meets or exceeds the predetermined threshold. If the user meets or exceeds the predetermined threshold, then process 600 may proceed to step 625, as disclosed herein.

Step 625 of process 600 may include removing the virtual barrier between the first extended reality zone and the second extended reality zone. Removing the virtual barrier may comprise allowing the user to virtually move between the first extended reality zone and the second extended reality zone. For example, after virtual reality barrier is removed, extended reality device may render viewing angles of the second extended reality zone and may allow for interaction with virtual reality content in the second extended reality zone. Removing the virtual barrier between the first extended reality zone and the second extended reality zone may comprise removing a rendering of the virtual barrier between the two zones. In other embodiments, when the virtual barrier is removed, the virtual barrier may still be virtually rendered between the first extended reality zone and the second extended reality zone, but the user may be permitted to virtually move past the virtual barrier into the second extended reality zone.

In some embodiments, process 600 may include comparing the progression input of the user to a predetermined threshold, determining that the progression input of the user does not meet the predetermined threshold, and generating content in the first extended reality zone. In some embodiments, the predetermined threshold may comprise a correct answer to a question, a number of correct answer to a plurality of questions, a completion of a task or assignment, or any other threshold that the progression input may be compared to. For example, the first extended reality zone may include a task with a plurality of questions and the predetermined threshold may comprise a minimum number of correct answers that the user must select. In another example, the first extended reality zone may include a video and the predetermined threshold may comprise a minimum amount of the video that the user must view. Process 600 may compare the progression input of the user to the predetermined threshold and may automatically determine that the user did not meet the predetermined threshold. If the user did not meet the predetermined threshold, then content may be generated in the first extended reality zone. The content generated in the first extended reality zone may comprise a video, an audio output, an image, virtual reality content, a presentation, a text book page, or any other content that may be related to the progression input. The content may provide additional explanation of the assignment and/or task to aid in the user's understanding of the assignment and/or task. In some embodiments, generating content may comprise providing an audio explanation of the progression input through a virtual character, such as virtual character 305 as disclosed herein with respect to FIG. 3.

In such embodiments, process 600 may further include receiving a second progression input from the user, comparing the progression input of the user to the predetermined threshold, determining that the progression input of the user meets the predetermined threshold, and removing the virtual barrier between the first extended reality zone and the second extended reality zone. Receiving the second progression input may correspond to receiving a progression input related to the first extended reality zone, as disclosed herein with respect to Step 620 of process 600. Process 600 may determine that the second progression input meets the predetermined threshold, as disclosed herein. Removing the virtual barrier may correspond to removing the virtual barrier between the first extended reality zone and the second extended reality zone, as disclosed herein with respect to Step 625 of process 600.

In some embodiments, process 600 may include receiving a content request input from the user and inserting a third extended reality device into the extended reality environment in response to the content request input. In some embodiments, the content request input may include a request to display a third extended reality zone. The content request input may be received through a gesture-based interaction (e.g., detectable by a motion sensor or other component of extended reality device 115) and/or an interaction through a keyboard, a mouse, or any other input/output devices (e.g., any of input/output devices 170) configured to allow user interaction with the first extended reality zone. In other embodiments, a content request input may include one or more gestures such as pointing actions, grabbing actions, holding actions, hovers, clicks, long presses, or the like. Additionally, voice inputs, gesture inputs using hands or fingers, or other NUI may also be used with the appropriate input devices, such as a microphone, camera, tablet, touch pad, glove, or other sensor.

Process 600 may include inserting the third extended reality zone into the extended reality environment in response to the received content request input. Inserting the third extended reality zone may comprise displaying the third extended reality zone adjacent to the second extended reality zone and, in some embodiments, providing a virtual barrier between the second extended reality zone and the third extended reality zone. In some embodiments, as disclosed herein, the extended reality zones may extend along a linear axis (e.g., may be rendered in a linear layout associated with an axis) in the extended reality environment. Inserting the third extended reality zone may include displaying the third extended reality zone adjacent to the second extended reality zone along the linear axis of extended reality zones. Inserting the third extended reality zone may further include rendering information boards, such as informational boards 215A-215C, within the third extended reality zone. Inserting the third extended reality zone may further include rendering a virtual barrier between the second extended reality zone and the third extended reality zone. The virtual barrier may correspond to virtual barrier 230, as disclosed herein with respect to FIG. 2, and may prevent the user from virtually moving between the second extended reality zone and the third extended reality zone.

In other embodiments, inserting the third extended reality zone into the extended reality environment may comprise forming a virtual space between the first extended reality zone and the second extended reality zone, displaying the third extended reality zone in the virtual space formed between the first extended reality zone and the second extended reality zone. Inserting the third extended reality zone into the extended reality environment may also comprise providing a first virtual barrier between the first extended reality zone and the third extended reality zone and/or providing a second virtual barrier between the third extended reality zone and the second extended reality zone. In such embodiments, the third extended reality zone may be virtually inserted in between the already existing first extended reality zone and the second extended reality zone.

Forming a virtual space may comprise virtually moving the second extended reality zone along the linear axis away from the first extended reality zone, virtually moving the first extended reality zone along the linear axis away from the second extended reality zone, or virtually move the first extended reality zone and the second extended reality zone in opposite directions along the linear axis. Virtually moving the first extended reality zone and/or the second extended reality zone may comprise rendering and/or displaying the extended reality zones in a new location in the extended reality environment. Virtually moving the extended reality zones may further comprise virtually moving any virtual reality content displayed in the extended reality zone.

Displaying the third extended reality zone in the virtual space formed between the first extended reality zone and the second extended reality zone may comprise rendering the third extended reality zone in the virtual space. The third extended reality zone may include digital and/or virtual content, such as a plurality of information boards, such as information boards 215A-215C as disclosed herein with respect to FIG. 2. The third extended reality zone may further include virtual reality objects. A virtual barrier may also be provided between the first extended reality zone and the third extended reality zone and between the third extended reality zone and the second extended reality zone. The virtual barriers may correspond to virtual barrier 230, as disclosed herein with respect to FIG. 2. The virtual barriers may prevent the user from virtually moving to the first extended reality zone or the second extended reality zone from the third extended reality zone located therebetween.

In some embodiments, the first extended reality zone may further include a virtual reality character configured to interact with the user. The virtual character may correspond to virtual character 305, as disclosed herein with respect to FIG. 3. For example, the virtual character may be a simulated representation of, and/or an interface with, a machine learning model (e.g., a model hosted or run by an extended reality device 115, computing device 120, a databases 125, or a server 130) and may be configured as a non-player character (e.g., avatar) and/or an interface for simulating human interaction, such as a computerized text-to-chat model.

In some embodiments, the user rendering associated with the user may animate based on interactions (e.g., movements, gestures, button presses) from the user. In some embodiments, the virtual character may be configured to animate and provide an audio output corresponding to a script to the user. For example, the virtual character may be configured to provide an audio output of an introductory script, a script explaining the virtual objects and/or information provided on information boards, a script explaining an assignment or task for the user to complete, or any other scripts. In some embodiments, the virtual character may begin providing the audio output of a script when the user (through a user rendering) virtually enters the extended reality zone, when the user is virtually located within a predetermined proximity of the virtual character, or when the user provides a gesture or audio input through an extended reality device, such as extended reality device 115.

In some embodiments, process 600 may further include displaying a virtual interface in the extended reality environment, receiving a selection input from the user, and virtually moving the user to the second extended reality zone in response to receiving the selection input. In some embodiments, the virtual interface may correspond to virtual interface 505 as disclosed herein with respect to FIG. 5. In some embodiments, a user may access the virtual interface through specific gestures or audio inputs. For example, the virtual interface may be displayed in the extended reality environment based on a gesture-based interaction (e.g., detectable by a motion sensor or other component of extended reality device 115) and/or an interaction through a keyboard, a mouse, or any other input/output devices (e.g., any of input/output devices 170). In other embodiments, the virtual interface may be displayed in the extended reality environment based on voice inputs, gesture inputs using hands or fingers, or other NUI may also be used with the appropriate input devices, such as a microphone, camera, tablet, touch pad, glove, or other sensor. The virtual interface may allow a user to change a view or a perspective of extended reality environment, render new virtual reality objects, view new or different videos, pictures, or other media, move between extended reality zones, interact with other users or virtual characters, among other actions. The virtual interface may comprise a plurality of selectable icons which may be virtually selected through a gesture-based interaction, voice input, or other inputs using appropriate input devices, as disclosed herein.

In some embodiments, the selectable icons may represent the first extended reality zone and the second extended reality zone. For example, a selectable icon of the virtual interface may display a three-dimensional rendering of the first extended reality zone and/or the second extended reality zone. In other embodiments, the selectable icon of the virtual interface may display a two-dimensional rendering of the first extended reality zone and/or the second extended reality zone. Displaying a three-dimensional or two-dimensional icon representing the first extended reality zone and/or the second extended reality zone may allow a user to quickly and easily identify an extended reality zone. For example, in some embodiments, the extended reality environment may contain dozens to hundreds of extended reality zones that may be associated with lessons, educational topics, assignments, classes, or other subjects. A user may want to move between extended reality zones to review information in the extended reality zones, complete tasks in the extended reality zones, or for other reasons. A three-dimensional or two-dimensional icon representing the extended reality zones may allow the user to identify which extended reality zone contains the information that the user is seeking.

Receiving the selection input from the user may comprise receiving a selection of the second extended reality zone. Receiving a selection of the second extended reality zone may include receiving a gesture-based input, voice input, or other input of an icon that represents the second extended reality zone. In response to receiving the selection input, process 600 may virtually move the user to the second extended reality zone. Virtually moving the user may comprise updating a rendering and/or display of the extended reality environment to present the second extended reality zone for the user to view through the extended reality device.

In some embodiments, process 600 may include receiving a movement input based on a hand gesture of the user and displaying a movement of a virtual representation of the user in the extended reality environment in a direction of the second extended reality zone. A movement input based on a hand gesture of the user may include an input through a gesture-based interaction (e.g., detectable by a motion sensor or other component of an extended reality device 115) and/or through a keyboard, a mouse, or any other input/output devices (e.g., any of input/output devices 170). The virtual representation of the user may correspond to user rendering 220, as disclosed herein with respect to FIG. 2. Displaying a virtual movement may comprise updating a display of the extended reality environment such that the second extended reality zone appears closer to the user. In some embodiments, a single input from the user may be sufficient to virtually move the user to another extended reality zone. In other embodiments, multiple inputs may cause the user to virtually move to another extended reality zone. The number of inputs for moving a user to another extended reality zone may be based on at least one of a virtual proximity of the user to the other extended reality zone or a type of input received (e.g., a hand gesture, a button press, a clicking motion). For example, a single hand gesture may virtually move (e.g., “scoot”) a user towards, but not into, an extended reality zone (e.g., multiple hand gestures may be needed depending on the user's virtual proximity to the extended reality zone), whereas a button press may virtually move the user into the extended reality zone. Displaying a movement of the virtual representation of the user may allow the user to virtually move within, between, and to the extended reality zones in the extended reality environment. In some embodiments, displaying a movement may comprise displaying a continuous movement of the user in a particular direction in the extended reality environment. In other embodiments, displaying a movement may comprise displaying an updated view of the extended reality environment (e.g., “teleporting” the user to a different location in the extended reality environment based on the movement input).

As used herein, unless specifically stated otherwise, being “based on” may include being dependent on, being derived from, being associated with, being influenced by, or being responsive to. As used herein, unless specifically stated otherwise, the term “or” encompasses all possible combinations, except where infeasible. For example, if it is stated that a component may include A or B, then, unless specifically stated otherwise or infeasible, the component may include A, or B, or A and B. As a second example, if it is stated that a component may include A, B, or C, then, unless specifically stated otherwise or infeasible, the component may include A, or B, or C, or A and B, or A and C, or B and C, or A and B and C.

Example embodiments are described above with reference to flowchart illustrations or block diagrams of methods, apparatus (systems) and computer program products. It will be understood that each block of the flowchart illustrations or block diagrams, and combinations of blocks in the flowchart illustrations or block diagrams, can be implemented by computer program product or instructions on a computer program product. These computer program instructions may be provided to a processor of a computer, or other programmable data processing apparatus to produce a machine, such that the instructions, which execute via the processor of the computer or other programmable data processing apparatus, create means for implementing the functions/acts specified in the flowchart or block diagram block or blocks.

These computer program instructions may also be stored in a computer-readable medium that can direct one or more hardware processors of a computer, other programmable data processing apparatus, or other devices to function in a particular manner, such that the instructions stored in the computer-readable medium form an article of manufacture including instructions that implement the function/act specified in the flowchart or block diagram block or blocks.

The computer program instructions may also be loaded onto a computer, other programmable data processing apparatus, or other devices to cause a series of operational steps to be performed (e.g., executed) on the computer, other programmable apparatus or other devices to produce a computer implemented process such that the instructions that execute on the computer or other programmable apparatus provide processes for implementing the functions/acts specified in the flowchart or block diagram block or blocks.

Any combination of one or more computer-readable medium(s) may be utilized. The computer-readable medium may be a non-transitory computer-readable storage medium. In the context of this document, a computer-readable storage medium may be any tangible medium that can contain or store a program for use by or in connection with an instruction execution system, apparatus, or device.

Program code embodied on a computer-readable medium may be transmitted using any appropriate medium, including but not limited to wireless, wireline, optical fiber cable, radio frequency (RF), infrared (IR), etc., or any suitable combination of the foregoing.

Computer program code for carrying out operations, for example, embodiments may be written in any combination of one or more programming languages, including an object-oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a LAN or a WAN, or the connection may be made to an external computer (for example, through the Internet using an Internet Service Provider).

The flowchart and block diagrams in the figures illustrate examples of the architecture, functionality, and operation of possible implementations of systems, methods, and computer program products according to various embodiments. In this regard, each block in the flowchart or block diagrams may represent a module, segment, or portion of code, which includes one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams or flowchart illustration, and combinations of blocks in the block diagrams or flowchart illustration, can be implemented by special purpose hardware-based systems that perform the specified functions or acts, or combinations of special purpose hardware and computer instructions.

It is understood that the described embodiments are not mutually exclusive, and elements, components, materials, or steps described in connection with one example embodiment may be combined with, or eliminated from, other embodiments in suitable ways to accomplish desired design objectives.

In the foregoing specification, embodiments have been described with reference to numerous specific details that can vary from implementation to implementation. Certain adaptations and modifications of the described embodiments can be made. Other embodiments can be apparent to those skilled in the art from consideration of the specification and practice of the invention disclosed herein. It is intended that the specification and examples be considered as exemplary only. It is also intended that the sequence of steps shown in figures are only for illustrative purposes and are not intended to be limited to any particular sequence of steps. As such, those skilled in the art can appreciate that these steps can be performed in a different order while implementing the same method.

1. A method for directing a user through an extended reality environment, the method comprising:
rendering, using at least one hardware processor, a first extended reality zone, wherein the first extended reality zone comprises a first delineated area within the extended reality environment in which the user may virtually move and a first plurality of information boards configured to display virtual reality content;
rendering, using the at least one hardware processor, a second extended reality zone adjacent to the first extended reality zone, wherein the second extended reality zone comprises a second delineated area within the extended reality environment in which the user may virtually move a second plurality of information boards configured to display virtual reality content;
providing, using the at least one hardware processor, a virtual barrier between the first extended reality zone and the second extended reality zone, wherein the virtual barrier prevents the user from virtually entering the second extended reality zone from the first extended reality zone;
receiving, using the at least one hardware processor and through an extended reality device, a progression input from the user, wherein the progression input comprises completing a minimum level of an assignment or a video associated with the first extended reality zone; and
removing, using the at least one hardware processor, in response to the progression input the virtual barrier between the first extended reality zone and the second extended reality zone, thereby permitting the user to virtually move between the first extended reality zone and the second extended reality zone.

2. The method of claim 1, wherein the method further comprises:
receiving a content request input from the user, wherein the content request input comprises a request to display a third extended reality zone; and
inserting the third extended reality zone into the extended reality environment in response to the content request input.

3. The method of claim 2, wherein inserting the third extended reality zone into the extended reality environment comprises:
displaying the third extended reality zone adjacent to the second extended reality zone; and
providing a virtual barrier between the second extended reality zone and the third extended reality zone.

4. The method of claim 2, wherein inserting the third extended reality zone into the extended reality environment comprises:
forming a virtual space between the first extended reality zone and the second extended reality zone;
displaying the third extended reality zone in the virtual space formed between the first extended reality zone and the second extended reality zone;
providing a first virtual barrier between the first extended reality zone and the third extended reality zone; and
providing a second virtual barrier between the third extended reality zone and the second extended reality zone.

5. The method of claim 2, wherein:
the first extended reality zone and the second extended reality zone are rendered in a linear layout associated with an axis; and
inserting the third extended reality zone into the extended reality environment comprises rendering the third extended reality zone along the axis to maintain the linear layout.

6. The method of claim 1, wherein providing a virtual barrier comprises displaying the virtual barrier as a boundary line between the first extended reality zone and the second extended reality zone.

7. The method of claim 1, wherein the first extended reality zone further comprises a virtual reality character configured to interact with the user.

8. The method of claim 1, wherein removing the virtual barrier allows the user to virtually move from the first extended reality zone to the second extended reality zone.

9. The method of claim 8, further comprising:
displaying a virtual interface in the extended reality environment, the virtual interface comprising at least one icon representing the first extended reality zone and the second extended reality zone;
receiving a selection input from the user, the selection input comprising a selection of the second extended reality zone; and
virtually moving the user to the second extended reality zone in response to receiving the selection input.

10. The method of claim 8, further comprising:
receiving a movement input based on a hand gesture of the user; and
displaying a movement of a virtual representation of the user in the extended reality environment in a direction of the second extended reality zone.

11. The method of claim 1, further comprising:
comparing the progression input of the user to a predetermined threshold; and
determining that the progression input of the user meets the predetermined threshold.

12. A non-transitory computer readable medium including instructions that, when executed by at least one hardware processor, cause the at least one hardware processor to perform operations for displaying an extended reality environment, the operations comprising:
rendering, a first extended reality zone comprising a first plurality of information boards configured to display virtual reality content;
rendering, a second extended reality zone adjacent to the first extended reality zone, wherein the second extended reality zone comprises a second plurality of information boards configured to display virtual reality content;
rendering, a virtual barrier between the first extended reality zone and the second extended reality zone, wherein the virtual barrier is configured to prevent a user from virtually moving between the first extended reality zone and the second extended reality zone unless a progression input is detected, wherein the progression input comprises completing a minimum level of an assignment or a video associated with the first extended reality zone; and
rendering, using the at least one hardware processor, in response to detecting the user virtually moving across a boundary line between the first extended reality zone and the second extended reality zone, digital content in the second extended reality zone.

13. The non-transitory computer readable medium of claim 12, wherein:
the first plurality of information boards comprises three information boards; and
the second plurality of information boards comprises three information boards.

14. The non-transitory computer readable medium of claim 12 wherein the virtual barrier is represented in the extended reality environment by a line displayed between the first extended reality zone and the second extended reality zone.

15. The non-transitory computer readable medium of claim 12, further comprising a virtual character configured to interact with the user, wherein the virtual character is rendered in at least one of the first extended reality zone or the second extended reality zone.

16. The non-transitory computer readable medium of claim 15, wherein the virtual character is associated with an artificial intelligence communication interface configured to receive a query from the user and provide answer data in response to the query.

17. The non-transitory computer readable medium of claim 15, wherein the virtual character is configured to play an audio output of a script to the user.

18. A system comprising:
at least one memory storing instructions;
at least one hardware processor configured to execute the instructions to perform operations for directing a user through an extended reality environment, the operations comprising:
rendering a first extended reality zone, wherein the first extended reality zone comprises a first plurality of information boards configured to display virtual reality content;
rendering a second extended reality zone adjacent to the first extended reality zone, wherein the second extended reality zone comprises a second plurality of information boards configured to display virtual reality content;
providing a virtual barrier between the first extended reality zone and the second extended reality zone, wherein the virtual barrier comprises digital information configured to prevent the user from virtually moving between the second extended reality zone from the first extended reality zone;
receiving, through an extended reality device, a progression input from the user, wherein the progression input comprises completing a minimum level of an assignment or a video associated with the first extended reality zone;
comparing the progression input of the user to a predetermined threshold,
determining that the progression input of the user does not meet the predetermined threshold; and
generating content in the first extended reality zone.

19. The system of claim 18, wherein the operations further comprise:
receiving a second progression input from the user;
comparing the second progression input of the user to the predetermined threshold;
determining that the second progression input of the user meets the predetermined threshold; and
removing, in response to the progression input, the virtual barrier between the first extended reality zone and the second extended reality zone.

20. The system of claim 18, wherein the operations further comprise displaying a virtual character configured to interact with the user in the first extended reality zone.

21. The method of claim 1, wherein removing the virtual barrier comprises removing a rendering of the virtual barrier between the first extended reality zone and the second extended reality zone.

22. The method of claim 1, wherein the removing the virtual barrier comprises permitting the user to virtually move past a rendering of the extended reality zone.

23. The method of claim 1, wherein the virtual barrier is not rendered in the extended reality environment.

24. The method of claim 1, further comprising:
rendering, using the at least one hardware processor, in response to detecting the user virtually moving across a boundary line between the first extended reality zone and the second extended reality zone, digital content in the second extended reality zone.

25. The method of claim 24, wherein the virtual barrier comprises digital information configured to prevent the user from virtually moving between the first extended reality zone and the second extended reality zone.

26. The method of claim 25, wherein the digital information includes at least one of a user location, a user rendering location, a zone location, or a zone dimension.
